(19) United States
(12) Patent Application Publication
(10) Pub. No.: US 2026/0352268 A1
(43) Pub. Date: Nov. 5, 2026

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/710,443

(22) Filed: Jun. 17, 2026

Related U.S. Application Data
(63) Continuation of application No. PCT/JP2024/038694, filed on Oct. 30, 2024.

(30) Foreign Application Priority Data
Dec. 28, 2023 (JP) 2023-223122

(51) Int. Cl. H04B 7/04; H01Q 15/14; H01Q 19/18

(52) U.S. Cl. CPC H04B 7/04013; H01Q 15/14; H01Q 19/18

(57) ABSTRACT

An intelligent reflecting surface includes a patch electrode over a first substrate, a counter electrode over a second substrate different from the first substrate, a liquid crystal layer between the patch electrode and the counter electrode, and in a plan view, a first region in which the counter electrode overlaps the patch electrode and a second region in which the counter electrode does not overlap the patch electrode. In the first region, the patch electrode includes a plurality of first opening portions having a first opening area, and the counter electrode includes a plurality of second opening portions having a second opening area. In the second region, the counter electrode includes a plurality of third opening portions having a third opening area. The plurality of second opening portions overlaps the plurality of first opening portions. The second opening area is larger than the first opening area.

### CROSS-REFERENCE TO RELATED APPLICATIONS

This application is a Continuation of International Patent Application No. PCT/JP2024/038694, filed on Oct. 30, 2024, which claims the benefit of priority to Japanese Patent Application No. 2023-223122, filed on Dec. 28, 2023, the entire contents of each are incorporated herein by reference.

### FIELD

An embodiment of the present invention relates to an intelligent reflecting surface capable of controlling the reflection direction of an incident radio wave.

### BACKGROUND

A phased array antenna device (hereinafter, referred to as a “intelligent reflecting surface”) has a plurality of antenna elements arranged in a plane, and controls the directionality of a radio wave by adjusting the amplitude and phase of a high-frequency signal applied to each of the plurality of antenna elements while the phased array antenna device is fixed. The phased array antenna device requires a phase shifter. The phased array antenna device including a phase shifter that uses a change in dielectric constant due to the alignment state of a liquid crystal is disclosed (for example, see Japanese laid-open patent application No. H11-103201).

The antenna element of the phased array antenna device in Japanese laid-open patent application No. H11-103201 has a plurality of strip wirings, a planar electrode facing the plurality of strip wirings, and a liquid crystal layer between the plurality of strip wirings and the planar electrode. Different voltages are applied to the plurality of strip wirings in the plurality of antenna elements. The phase can be changed by adjusting the dielectric constant of the liquid crystal layer for each antenna element and superposing the reflected waves. In this way, the reflecting direction of the radio wave can be set in any direction.

### SUMMARY

An intelligent reflecting surface according to an embodiment of the present invention includes a patch electrode over a first substrate, a counter electrode over a second substrate different from the first substrate, a liquid crystal layer between the patch electrode and the counter electrode, and in a plan view, a first region in which the counter electrode overlaps the patch electrode and a second region in which the counter electrode does not overlap the patch electrode. In the first region, the patch electrode includes a plurality of first opening portions having a first opening area, and the counter electrode includes a plurality of second opening portions having a second opening area. In the second region, the counter electrode includes a plurality of third opening portions having a third opening area. The plurality of second opening portions overlaps the plurality of first opening portions. The second opening area is larger than the first opening area.

An intelligent reflecting surface according to an embodiment of the present invention includes a patch electrode over a first substrate, a counter electrode over a second substrate different from the first substrate, a liquid crystal layer between the patch electrode and the counter electrode, and in a plan view, a first region in which the counter electrode overlaps the patch electrode and a second region in which the counter electrode does not overlap the patch electrode. In the first region, the patch electrode includes a plurality of first opening portions having a first opening area, and the counter electrode includes a plurality of second opening portions having a second opening area. In the second region, the counter electrode includes a plurality of third opening portions having a third opening area. The plurality of second opening portions overlaps the plurality of first opening portions. The second opening area is smaller than the first opening area.

### BRIEF DESCRIPTION OF DRAWINGS

FIG. 1 is a schematic plan diagram showing an outline of a configuration of an intelligent reflecting surface according to an embodiment of the present invention.

FIG. 2 is a schematic cross-sectional view showing a configuration of a reflecting antenna cell of an intelligent reflecting surface according to an embodiment of the present invention and a reflection direction of a radio wave by the reflecting antenna cell.

FIG. 3 is a schematic plan view showing a configuration of a patch electrode and a counter electrode of an intelligent reflecting surface according to an embodiment of the present invention.

FIG. 4A is a schematic plan view showing an electrode pattern of a patch electrode of an intelligent reflecting surface according to an embodiment of the present invention.

FIG. 4B is a schematic plan view showing an electrode pattern of a counter electrode of an intelligent reflecting surface according to an embodiment of the present invention.

FIG. 5 is a schematic plan view showing a configuration of a first region of an intelligent reflecting surface according to an embodiment of the present invention.

FIG. 6 is a schematic cross-sectional view showing a configuration of a first region of an intelligent reflecting surface according to an embodiment of the present invention.

FIG. 7 is a schematic plan view showing configurations of a patch electrode and a counter electrode of an intelligent reflecting surface according to an embodiment of the present invention.

FIG. 8A is a schematic plan view showing an electrode pattern of a patch electrode of an intelligent reflecting surface according to an embodiment of the present invention.

FIG. 8B is a schematic plan view showing an electrode pattern of a counter electrode of an intelligent reflecting surface according to an embodiment of the present invention.

FIG. 9 is a schematic plan view showing configurations of a patch electrode and a counter electrode of an intelligent reflecting surface according to an embodiment of the present invention.

FIG. 10 is a schematic plan view showing an electrode pattern of a counter electrode of an intelligent reflecting surface according to an embodiment of the present invention.

FIG. 11 is a schematic plan view showing a configuration of a patch electrode and a counter electrode of an intelligent reflecting surface according to an embodiment of the present invention.

FIG. 12 is a schematic plan view showing an electrode pattern of a counter electrode of an intelligent reflecting surface according to an embodiment of the present invention.

FIG. 13 is a schematic plan view showing a configuration of a patch electrode and a counter electrode of an intelligent reflecting surface according to an embodiment of the present invention.

FIG. 14A is a schematic plan view showing an electrode pattern of a patch electrode of an intelligent reflecting surface according to an embodiment of the present invention.

FIG. 14B is a schematic plan view showing an electrode pattern of a counter electrode of an intelligent reflecting surface according to an embodiment of the present invention.

FIG. 15 is a schematic plan view showing a configuration of a patch electrode and a counter electrode of an intelligent reflecting surface according to an embodiment of the present invention.

FIG. 16 is a schematic plan view showing an electrode pattern of a counter electrode of an intelligent reflecting surface according to an embodiment of the present invention.

### DESCRIPTION OF EMBODIMENTS

An intelligent reflecting surface can simplify a radio base station. However, there is a problem in that the installation of the intelligent reflecting surface spoils the landscape. Therefore, a transparent intelligent reflecting surface is in demand for use in a fifth-generation mobile communication system (5G). The transparent intelligent reflecting surface can be made using a liquid crystal. However, even with the transparent intelligent reflecting surface using the liquid crystal, an in-plane variation in transparency is a problem, such as the shape of the electrodes contained in the intelligent reflecting surface being visible. Therefore, improvement of the in-plane variation in transparency of the transparent intelligent reflecting surface is desired.

In view of the above problems, an embodiment of the present invention can provide a transparent intelligent reflecting surface in which an in-plane variation in transparency is suppressed.

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each component are a convenience sign used to distinguish them and have no further meaning except as otherwise explained.

As used in the present specification, where a member or region is “on” (or “under”) another member or region, this includes cases where it is not only directly on (or just under) the other member or region but also above (or below) the other member or region, unless otherwise specified. That is, it includes the case where another component is included in between above (or below) other members or regions.

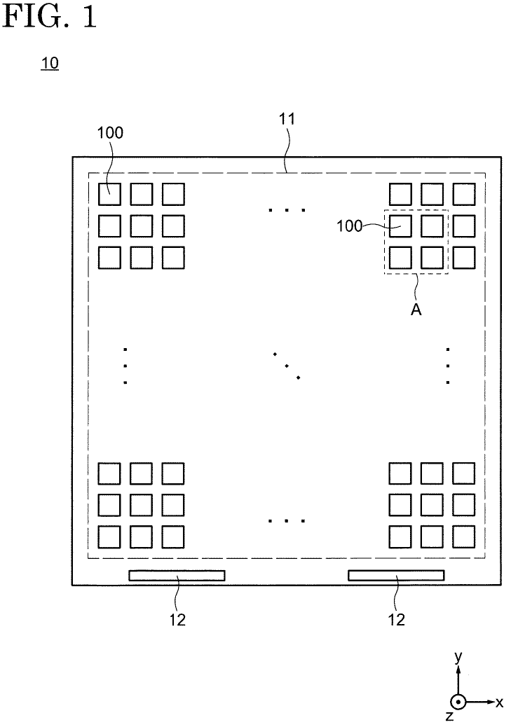

An intelligent reflecting surface 10 according to an embodiment of the present invention is described with reference to FIGS. 1 to 6.

### 1. Configuration of Intelligent Reflecting Surface 10

FIG. 1 is a schematic plan view showing an outline of a configuration of the intelligent reflecting surface 10 according to an embodiment of the present invention.

As shown in FIG. 1, the intelligent reflecting surface 10 includes a reflecting antenna region 11 and a driving circuit region 12. The reflecting antenna region 11 is provided in the center of the intelligent reflecting surface 10, and the driving circuit region 12 is provided in the peripheral region of the intelligent reflecting surface 10. In other words, the driving circuit region 12 is provided around the reflecting antenna region 11. The reflecting antenna region 11 is provided with a plurality of reflecting antenna cells 100. The plurality of reflecting antenna cells 100 are arranged in a matrix in an x-axis direction and a y-axis direction. However, the arrangement configuration of the plurality of reflecting antenna cells 100 is not limited thereto. The driving circuit region 12 is provided with a drive circuit that generates control signals to control each of the plurality of reflecting antenna cells 100. Although not shown in the figures, terminals for supplying signals or power from the outside may be provided in the peripheral region of the intelligent reflecting surface 10.

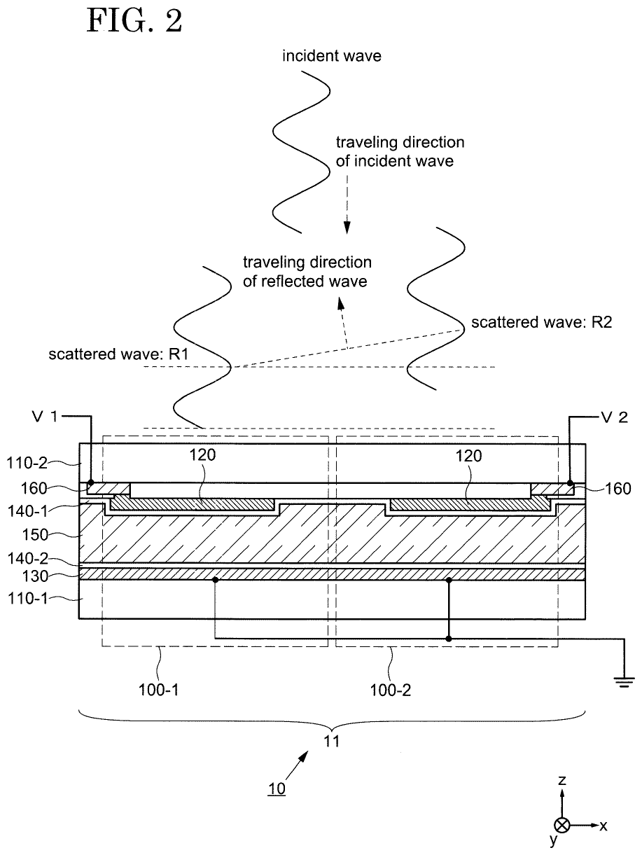

Here, a configuration and a function of the reflecting antenna cell 100 are described with reference to FIG. 2.

FIG. 2 is a schematic cross-sectional view showing the configuration of the reflecting antenna cell 100 of the intelligent reflecting surface 10 according to an embodiment of the present invention and a reflection direction of a radio wave by the reflecting antenna cell 100. In FIG. 2, two adjacent reflecting antenna cells 100 are shown as a first reflecting antenna cell 100-1 and a second reflecting antenna cell 100-2.

Each of the first reflecting antenna cell 100-1 and the second reflecting antenna cell 100-2 includes a patch electrode 120 provided on a first substrate 110-1 and a counter electrode 130 provided on a second substrate 110-2. The patch electrode 120 of the first reflecting antenna cell 100-1 and the patch electrode 120 of the second reflecting antenna cell 100-2 are not electrically connected to each other. On the other hand, the counter electrode 130 is provided in common to both the first reflecting antenna cell 100-1 and the second reflecting antenna cell 100-2. A first alignment film 140-1 is provided on the patch electrode 120. A second alignment film 140-2 is provided on the counter electrode 130. The first substrate 110-1 and the second substrate 110-2 are arranged so that the patch electrode 120 and the counter electrode 130 face each other, and a liquid crystal layer 150 is provided between the first alignment film 140-1 and the second alignment film 140-2.

Glass, quartz, or resin can be used for each of the first substrate 110-1 and the second substrate 110-2.

A metal material can be used for each patch electrode 120 and the counter electrode 130. For example, the metal material may be molybdenum (Mo), tungsten (W), titanium (Ti), aluminum (Al), or copper (Cu), or an alloy thereof. The patch electrode 120 and the counter electrode 130 may each have a single layer structure or a laminated structure.

Polyimide resin or the like can be used for each of the first alignment film 140-1 and the second alignment film 140-2. An alignment treatment using methods such as rubbing or photo-alignment is performed on the first alignment film 140-1 and the second alignment film 140-2.

The liquid crystal layer 150 contains a liquid crystal material having dielectric anisotropy. For example, a nematic liquid crystal or a cholesteric liquid crystal containing liquid crystal molecules capable of a twist alignment can be used as the liquid crystal material of the liquid crystal layer 150. Further, it is preferable that the liquid crystal layer 150 contains a chiral agent to stabilize the twist orientation of the liquid crystal molecules.

The initial alignment (alignment state when no voltage is applied) of the liquid crystal molecules in the liquid crystal layer 150 is controlled by the first alignment film 140-1 and the second alignment film 140-2 on which the alignment treatment is performed. When a voltage is applied to the patch electrode 120 and a potential difference is generated between the patch electrode 120 and the counter electrode 130, the alignment state of the liquid crystal molecules in the liquid crystal layer 150 changes, and the dielectric constant of the liquid crystal layer 150 also changes. Although details are described layer, the intelligent reflecting surface 10 uses the change in the dielectric constant of the liquid crystal layer 150 to control the phase of a reflected wave.

In the case where the liquid crystal molecules have positive dielectric anisotropy, the dielectric constant is greater when a voltage is applied than when no voltage is applied. In the case where the liquid crystal molecules have negative dielectric anisotropy, the dielectric constant is smaller when a voltage is applied than when no voltage is applied. The liquid crystal layer 150 formed of the liquid crystal having dielectric anisotropy can also be considered as a variable dielectric layer. The reflecting antenna cell 100 can control the phase of the radio wave scattered by the counter electrode 130 to be delayed (or not delayed) by using the dielectric anisotropy of the liquid crystal layer 150.

As described above, the basic configurations of the first reflecting antenna cell 100-1 and the second reflecting antenna cell 100-2 are the same. That is, each of the plurality of reflecting antenna cells 100 has the basic configuration described above. On the other hand, each of the plurality of reflecting antenna cells 100 is electrically connected to a switching element 160. Specifically, the switching element 160 is electrically connected to the patch electrode 120, and the voltage applied to the patch electrode 120 changes by controlling the switching element 160.

As shown in FIG. 2, radio waves are incident on the intelligent reflecting surface 10 parallel to the normal direction of the surface of the first substrate 110-1 (see “traveling direction of incident wave” in FIG. 2). Here, it is considered that a first voltage V1 is applied to the patch electrode 120 of the first reflecting antenna cell 100-1, and a second voltage V2, which is different from the first voltage V1, is applied to the patch electrode 120 of the second reflecting antenna cell 100-2. When the radio wave with the same phase is incident on the first reflecting antenna cell 100-1 and the second reflecting antenna cell 100-2, scattered waves with different phases are generated in the first reflecting antenna cell 100-1 and the second reflecting antenna cell 100-2 because the dielectric constants of the liquid crystal layer 150 are different in the first reflecting antenna cell 100-1 and the second reflecting antenna cell 100-2. For example, as shown in FIG. 2, the phase of the scattered wave R2 scattered by the second reflecting antenna cell 100-2 leads the phase of the scattered wave R1 scattered by the first reflecting antenna cell 100-1. In this case, the radio wave reflected in the reflecting antenna region 11 travels in a direction different from the normal direction of the surface of the first substrate 110-1 (see “traveling direction of reflected wave” in FIG. 2). Although FIG. 2 shows two adjacent reflecting antenna cells 100, the intelligent reflecting surface 10 can control the plurality of reflecting antenna cells 100 arranged in a matrix independently. Therefore, the intelligent reflecting surface 10 can control the reflecting direction of the radio wave to any desired direction.

The frequency bands to which the intelligent reflecting surface 10 is applicable are the very high frequency (VHF) band, the ultra-high frequency (UHF) band, the super high frequency (SHF) band, the tremendously high frequency (THF) band, and the extra high frequency (EHF) band. As described above, the alignment state of the liquid crystal molecules in the liquid crystal layer 106 changes depending on the voltage applied to the patch electrode 120. However, the alignment state of the liquid crystal molecules does not follow the frequency of the radio wave incident on the counter electrode 130. Due to such characteristics of the liquid crystal molecules, it is possible to change the dielectric constant of the liquid crystal layer 150 by the patch electrode 120 while scattering the radio wave at the counter electrode 130 and control the phase of the scattered wave.

### 2. Configuration of Patch Electrode 120 and Counter Electrode 130

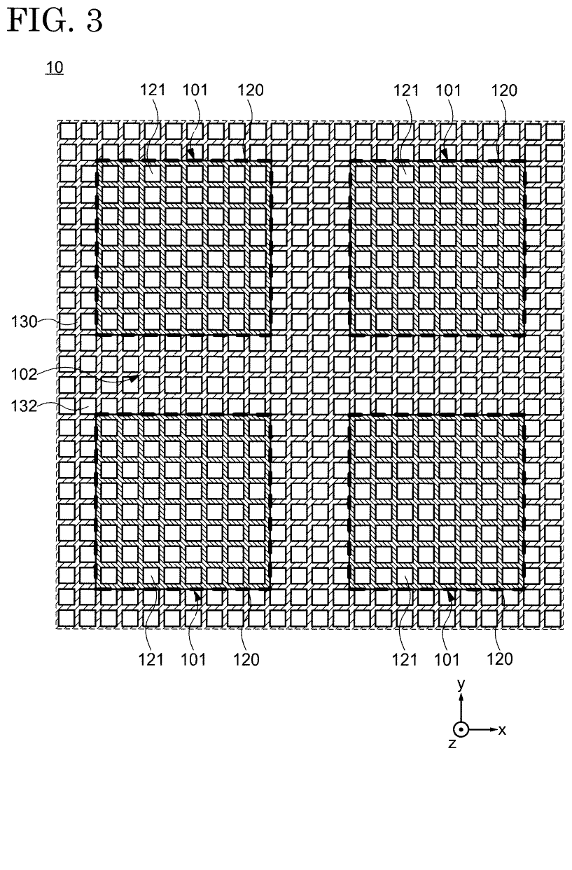

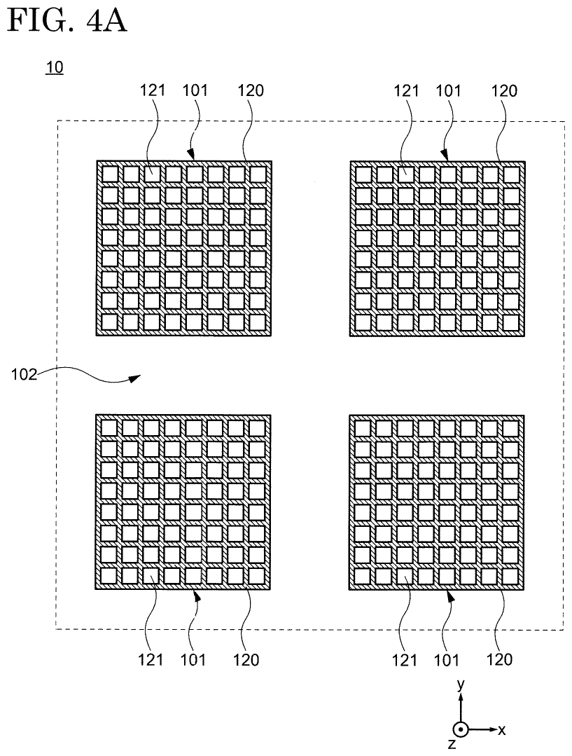

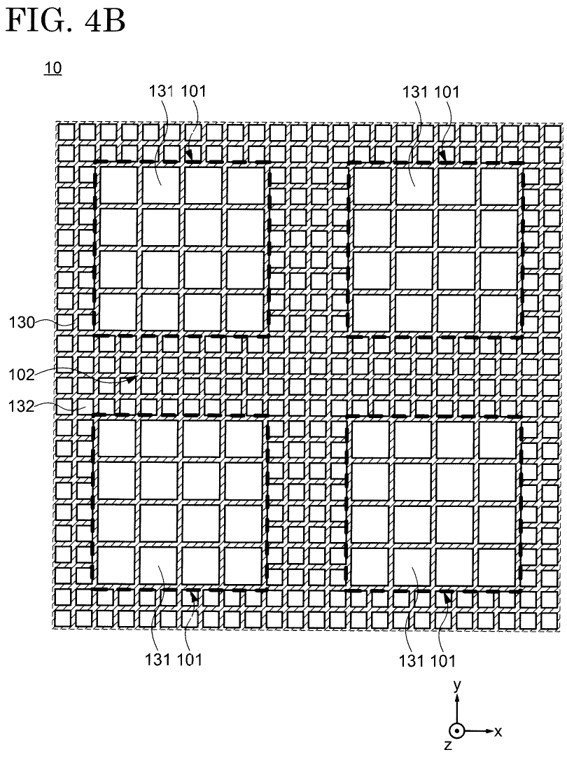

FIG. 3 is a schematic plan view showing a configuration of the patch electrode 120 and the counter electrode 130 of the intelligent reflecting surface 10 according to an embodiment of the present invention. Specifically, FIG. 3 is a partially enlarged view of a region A in FIG. 1, which includes the four reflecting antenna cells 100. FIG. 4A is a schematic plan view showing an electrode pattern of the patch electrode 120 of the intelligent reflecting surface 10 according to an embodiment of the present invention, and FIG. 4B is a schematic plan view showing an electrode pattern of the counter electrode 130 of the intelligent reflecting surface 10 according to an embodiment of the present invention. The plan views in FIGS. 4A and 4B correspond to the plan view in FIG. 3.

The intelligent reflecting surface 10 includes a first region 101 and a second region 102. The first region 101 is a region where the patch electrode 120 and the counter electrode 130 overlap each other in the plan view. That is, the first region 101 is the region corresponding to the reflecting antenna cell 100. The second region 102 is a region where the patch electrode 120 and the counter electrode 130 do not overlap each other in the plan view. That is, the second region 102 is the region where only the counter electrode 130 is provided.

In the first region 101, the patch electrode 120 includes a plurality of first opening portions 121 having a first opening area (see FIG. 4A). Further, in the first region 101, the counter electrode 130 includes a plurality of second opening portions 131 having a second opening area (see FIG. 4B). Although the planar shape of each of the first opening portions 121 and the second opening portions 131 is rectangular, the cross-sectional shape is not limited thereto. The second opening area is larger than the first opening area. Furthermore, the first opening portion 121 and the second opening portion 131 overlap each other. Specifically, one of the plurality of second opening portions 131 overlaps four of the plurality of first opening portions 121.

In the second region 102, the counter electrode 130 includes a plurality of third opening portions 132 having a third opening area (see FIG. 4B). Although the planar shape of the third opening is rectangular, the cross-sectional shape is not limited thereto. The third opening area is the same as the first opening area. In other words, the aperture ratio of the counter electrode 130 in the second region 102 is smaller than the aperture ratio of the counter electrode 130 in the first region 101.

The patch electrode 120 and the counter electrode 130 do not transmit light. However, in the intelligent reflecting surface 10, many opening portions (the plurality of first opening portions 121, the plurality of second opening portions 131, and the plurality of third opening portions 132) are provided in the patch electrode 120 and the counter electrode 130 to transmit light, and light incident on the intelligent reflecting surface 10 passes through the opening portions. Therefore, the intelligent reflecting surface 10 becomes a transparent intelligent reflecting surface.

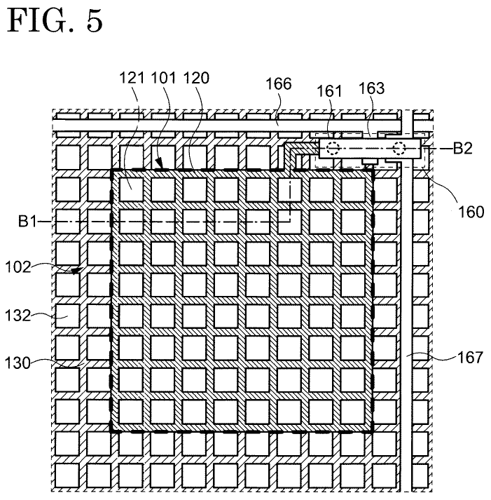

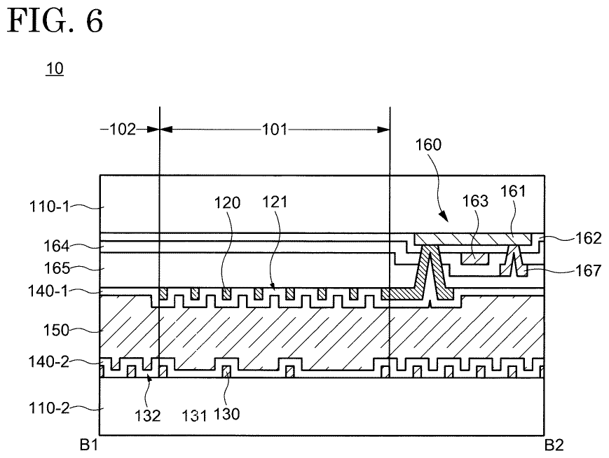

Here, the configurations of the patch electrode 120 and the counter electrode 130 in the first region 101 of the transparent intelligent reflecting surface 10 are described in more detail with reference to FIGS. 5 and 6.

FIG. 5 is a schematic plan view showing the configuration of the first region 101 of the intelligent reflecting surface 10 according to an embodiment of the present invention. FIG. 6 is a schematic cross-sectional view showing the configuration of the first region 101 of the intelligent reflecting surface 10 according to an embodiment of the present invention. Specifically, FIG. 6 is a cross-sectional view of the first region 101 cut along a line B1-B2 in FIG. 5. As described above, the first region 101 corresponds to the reflecting antenna cell 100.

FIGS. 5 and 6 show a transistor as an example of a switching element 160. Specifically, the switching element 160 includes a semiconductor layer 161, a gate insulating layer 162, and a gate electrode 163. The semiconductor layer 161 is provided on the first substrate 110-1. The gate insulating layer 162 is provided on the first substrate 110-1 so as to cover the semiconductor layer 161. The gate electrode 163 is provided on the gate insulating layer 162 so as to overlap the semiconductor layer 161. The gate electrode 163 is electrically connected to a selection signal line 166. An interlayer insulating layer 164 is provided on the gate electrode 163. The interlayer insulating layer 164 includes two opening portions through which the semiconductor layer 161 is exposed. The semiconductor layer 161 is electrically connected to a patch electrode 120 through one opening portion and to a data signal line 167 through the other opening portion. A planarization layer 165 is provided on the interlayer insulating layer 164 and the data signal line 167. The patch electrode 120 is provided on the planarization layer 165.

The semiconductor layer 161 is formed using a silicon semiconductor such as amorphous silicon or polycrystalline silicon, or an oxide semiconductor such as indium gallium zinc oxide, indium gallium aluminum oxide, indium gallium oxide, zinc oxide, or gallium oxide. The gate insulating layer 162 and the interlayer insulating layer 164 are formed using, for example, a silicon oxide film, or a laminated structure of a silicon oxide film and a silicon nitride film. The gate electrode 163 and the selection signal line 166 may be formed in the same layer. The gate electrode 163 and the selection signal line 166 are formed using, for example, molybdenum (Mo) or tungsten (W), or an alloy thereof. The data signal line 167 is formed using a metal material such as titanium (Ti), aluminum (Al), or molybdenum (Mo). For example, the data signal line 167 is formed of a titanium (Ti)/aluminum (Al)/titanium (Ti) laminated structure or a molybdenum (Mo)/aluminum (Al)/molybdenum (Mo) laminated structure. The planarization layer 165 is formed using a resin material such as acrylic or polyimide.

The selection signal line 166 and the data signal line 167 are electrically connected to the drive circuit in the driving circuit region 12. Control signals from the drive circuit are input to the switching element 160 via the selection signal line 166 and the data signal line 167. The switching element 160 operates based on the control signals, thereby changing the alignment state of the liquid crystal molecules in the liquid crystal layer 150.

Incidentally, the transparency of the intelligent reflecting surface 10 is related to the light transmittance of the intelligent reflecting surface 10. For example, when the amount of light transmitted through the intelligent reflecting surface 10 increases, the transparency of the intelligent reflecting surface 10 improves. Light incident on the intelligent reflecting surface 10 is mainly blocked by the patch electrode 120 and the counter electrode 130. Only the counter electrode 130 is provided in the second region 102. On the other hand, both the patch electrode 120 and the counter electrode 130 are provided in the first region 101. Therefore, light incident on the intelligent reflecting surface 10 is more easily blocked in the first region 101 than in the second region 102. For this reason, the transparency of the first region 101 is generally lower than that of the second region 102. However, since the second opening area of the second opening portion 131 is large in the first region 101 of the intelligent reflecting surface 10, light is unlikely to be blocked by the counter electrode 130. Further, light enters the intelligent reflecting surface 10 from all directions, not just the direction normal to the first substrate 110-1 or the second substrate 110-2. However, when the second opening area of the second aperture 131 is large, light entering from all directions is more easily transmitted through the first region 101. As a result, the difference between the transparency of the first region 101 and the transparency of the second region 102 becomes smaller, and the in-plane variation in transparency in the intelligent reflecting surface 10 can be reduced.

As described above, in the first region 101 (the reflecting antenna cell 100) of the intelligent reflecting surface 10, the second opening area of the second opening portion 131 provided in the counter electrode 130 is larger than the first opening area of the first opening portion 121 provided in the patch electrode 120. Therefore, since light shielding by the counter electrode 130 is reduced, the amount of light transmitted through the first region 101 increases. As a result, the transparency of the first region 101 is improved. Further, the first opening portion 121 in the first region 101 and the third opening portion 132 in the second region 102 are the same in shape and size. Therefore, since the brightness of the light transmitted through the first region 101 is approximately the same as the brightness of the light transmitted through the second region 102, the in-plane variation in transparency in the intelligent reflecting surface 10 can be reduced.

### Modification 1

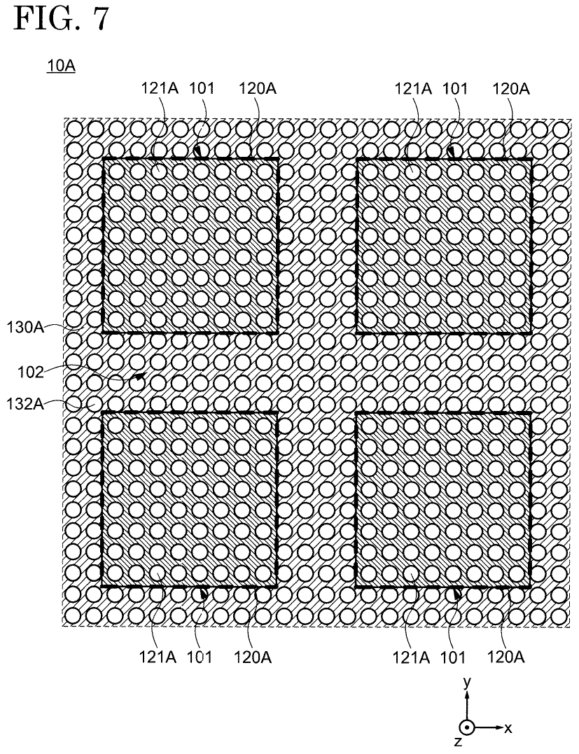

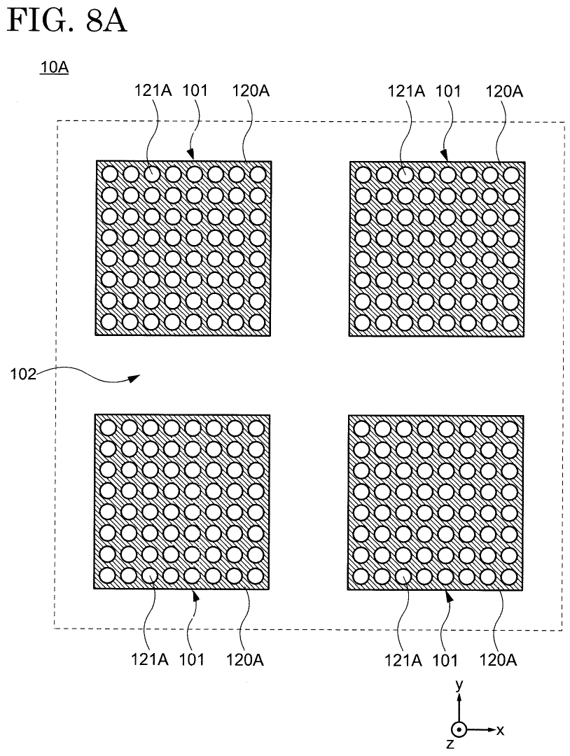

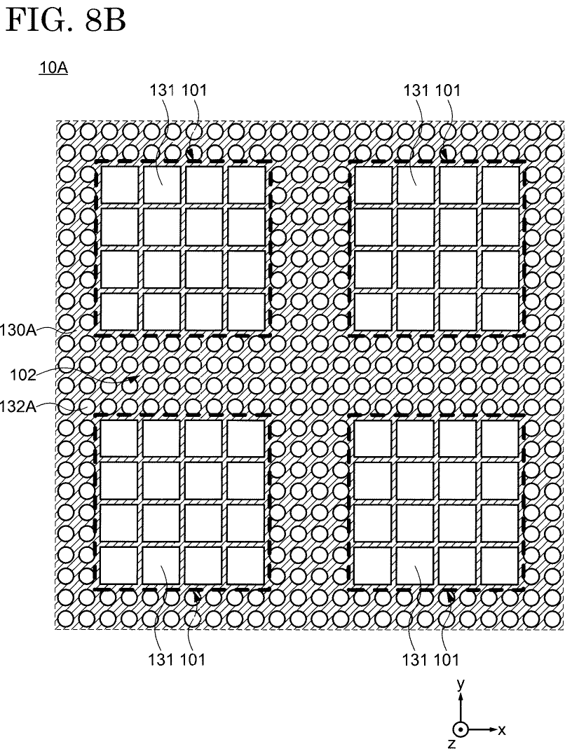

An intelligent reflecting surface 10A, which is the first modification of the intelligent reflecting surface 10, is described with reference to FIGS. 7 to 8B. In addition, hereinafter, when the intelligent reflecting surface 10A includes the same components as the intelligent reflecting surface 10, the description of those components may be omitted.

FIG. 7 is a schematic plan view showing configurations of a patch electrode 120A and a counter electrode 130A of the intelligent reflecting surface 10A according to an embodiment of the present invention. FIG. 7 is a plan view corresponding to the region A in FIG. 1. FIG. 8A is a schematic plan view showing an electrode pattern of the patch electrode 120A of the intelligent reflecting surface 10A according to an embodiment of the present invention, and FIG. 8B is a schematic plan view showing an electrode pattern of the counter electrode 130A of the intelligent reflecting surface 10A according to an embodiment of the present invention. The plan views of FIGS. 8A and 8B correspond to the plan view of FIG. 7.

In a plan view, the intelligent reflecting surface 10A includes a first region 101 where the patch electrode 120A and the counter electrode 130A overlap each other, and a second region 102 where the patch electrode 120A and the counter electrode 130A do not overlap each other.

In the first region 101, the patch electrode 120A includes a plurality of first opening portions 121A having a first opening area (see FIG. 8A). Further, in the first region 101, the counter electrode 130A includes a plurality of second opening portions 131 having a second opening area (see FIG. 8B). The planar shape of the first opening portions 121A is circular, and the planar shape of the second opening portions 131 is rectangular. Furthermore, the second opening area is larger than the first opening area. Thus, although the first opening portion 121A and the second opening portion 131 differ in shape and size, they overlap each other in the first region 101. Specifically, one of the plurality of second opening portions 131 overlaps four of the plurality of first opening portions 121A. Since the light transmitted through the first opening portion 121A and the second opening portion 131 is not blocked by the patch electrode 120A and the counter electrode 130A, the first region 101 has transparency.

In the second region 102, the counter electrode 130A includes a plurality of third opening portions 132A having a third opening area (see FIG. 8B). Since the light transmitted through the third opening portions 132A is not blocked by the patch electrode 120A and the counter electrode 130A, the second region 102 has transparency. The planar shape of the third opening portions 132A is rectangular. The third opening area is the same as the first opening area. That is, the third opening portions 132A have the same shape and size as the first opening portions 121A.

As described above, in the first region 101 (the reflecting antenna cell 100) of the intelligent reflecting surface 10A, the first opening portion 121A provided in the patch electrode 120A and the second opening portion 131 provided in the counter electrode differ in shape and size. However, since the second opening area of the second opening portion 131 is larger than the first opening area of the first opening portion 121A, the light shielding by the counter electrode 130A is reduced, and the amount of light transmitted through the first region 101 increases. As a result, the transparency of the first region 101 is improved. Further, the first opening portion 121A in the first region 101 and the third opening portion 132A in the second region 102 are the same in shape and size. Therefore, since the brightness of the light transmitted through the first region 101 is approximately the same as the brightness of the light transmitted through the second region 102, the in-plane variation in transparency of the intelligent reflecting surface 10A can be reduced.

### Modification 2

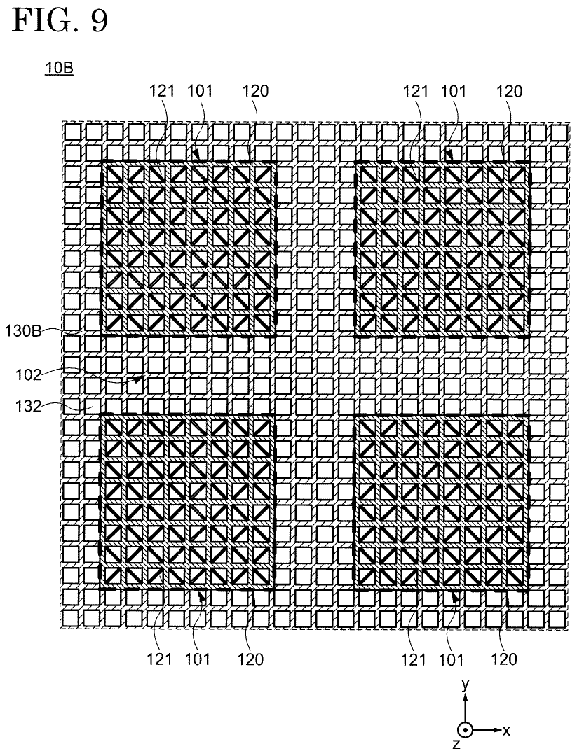

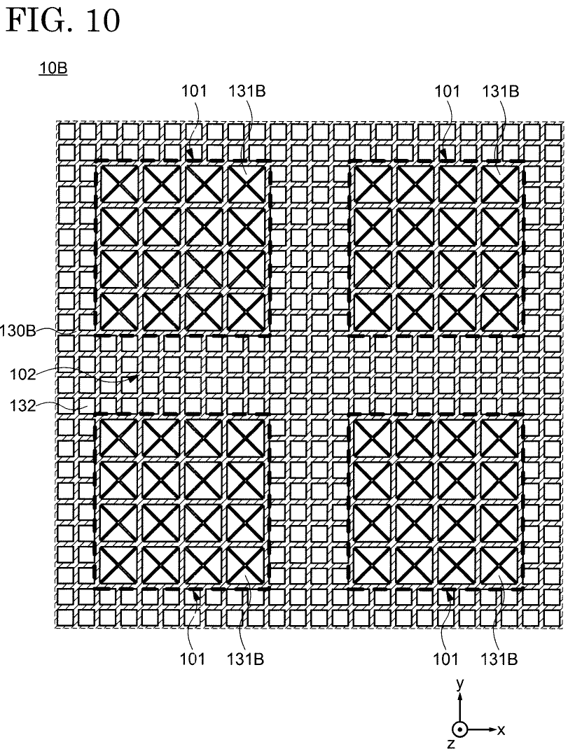

An intelligent reflecting surface 10B, which is the second modification of the intelligent reflecting surface 10, is described with reference to FIGS. 9 and 10. In addition, hereinafter, when the intelligent reflecting surface 10B includes the same components as the intelligent reflecting surface 10, the description of those components may be omitted.

FIG. 9 is a schematic plan view showing configurations of the patch electrode 120 and a counter electrode 130B of the intelligent reflecting surface 10B according to an embodiment of the present invention. FIG. 9 is a plan view corresponding to the region A in FIG. 1. Further, FIG. 10 is a schematic plan view showing an electrode pattern of the counter electrode 130B of the intelligent reflecting surface 10B according to an embodiment of the present invention. The plan view of FIG. 10 corresponds to the plan view of FIG. 9. The electrode pattern of the patch electrode 120 of the intelligent reflecting surface 10B is the same as the electrode pattern shown in FIG. 4A.

In a plan view, the intelligent reflecting surface 10B includes a first region 101 where the patch electrode 120 and the counter electrode 130B overlap each other, and a second region 102 where the patch electrode 120 and the counter electrode 130B do not overlap each other.

In the first region 101, the counter electrode 130B includes a plurality of second opening portions 131B having a second opening area (see FIG. 10). The planar shape of the first opening portion 121 is rectangular, and the planar shape of the second opening portion 131B is triangular. The distance between two adjacent second opening portions 131B (i.e., the line width of the counter electrode 130B located between two adjacent second opening portions 131B) is smaller than the distance between two adjacent first opening portions 121 (i.e., the line width of the patch electrode 120 located between two adjacent first opening portions 121). Therefore, the second opening area is larger than the first opening area. Although the first opening portion 121 and the second opening portion 131B differ in shape and size, they overlap in the first region 101. Specifically, one of the plurality of second opening portions 131B overlaps two of the plurality of first opening portions 121. In this way, one of the plurality of second opening portions 131B can overlap any number of the plurality of first opening portions 121. However, when too many first opening portions 121 overlap one of the plurality of second opening portions 131B, it becomes difficult to generate a potential difference between the patch electrode 120 and the counter electrode 130, and the alignment state of the liquid crystal molecules may not change even when a voltage is applied to the patch electrode 120. In this case, the reflection loss of the intelligent reflecting surface 10B increases. Therefore, in order to suppress the increase in the reflection loss of the intelligent reflecting surface 10B, it is preferable that one of the plurality of second opening portions 131B overlap two to four of the plurality of first opening portions 121.

As described above, in the first region 101 (the reflecting antenna cell 100) of the intelligent reflecting surface 10B, one of the plurality of second opening portions 131B can overlap any number of the plurality of first opening portions 121. Even in this case, since the second opening area of the second opening portion 131B is larger than the first opening area of the first opening portion 121, light shielding by the counter electrode 130 is reduced, and the amount of light transmitted through the first region 101 of the intelligent reflecting surface 10B increases. As a result, the transparency of the first region 101 is improved. Further, the first opening portion 121 of the first region 101 and the third opening portion 132 of the second region 102 have the same shape and size. Therefore, since the brightness of the light transmitted through the first region 101 is approximately the same as the brightness of the light transmitted through the second region 102, the in-plane variation in transparency in the intelligent reflecting surface 10B can be reduced.

### Modification 3

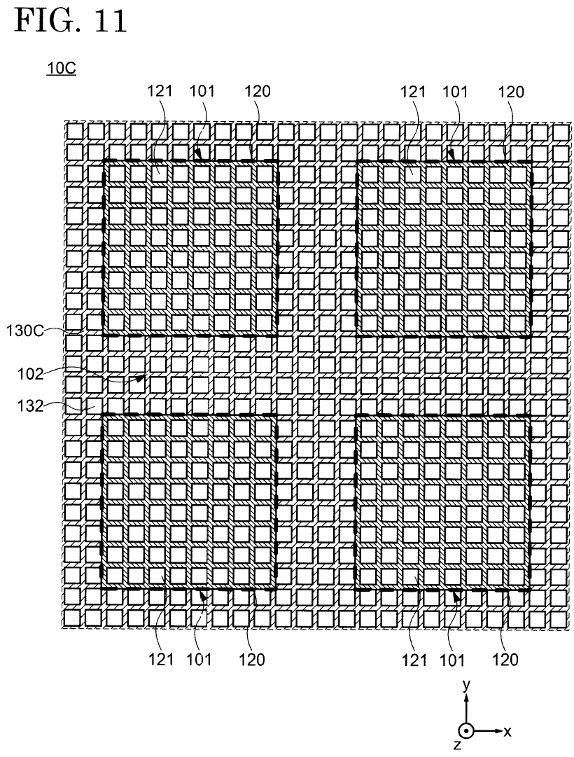

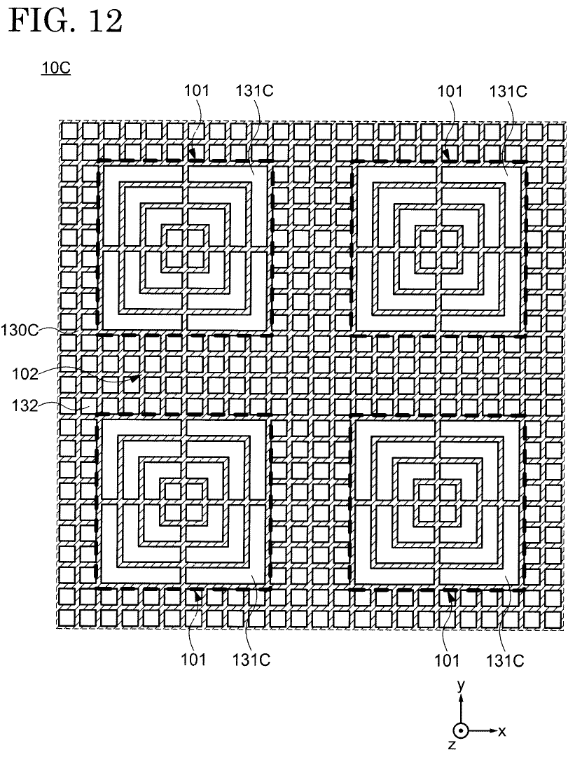

An intelligent reflecting surface 10C, which is the third modification of the intelligent reflecting surface 10, is described with reference to FIGS. 11 and 12. In addition, hereinafter, when the intelligent reflecting surface 10C includes the same components as the intelligent reflecting surface 10, the description of those components may be omitted.

FIG. 11 is a schematic plan view showing configurations of the patch electrode 120 and a counter electrode 130C of the intelligent reflecting surface 10C according to an embodiment of the present invention. FIG. 12 is a plan view corresponding to the region A in FIG. 1. Further, FIG. 12 is a schematic plan view showing an electrode pattern of the counter electrode 130C of the intelligent reflecting surface 10C according to an embodiment of the present invention. The plan view of FIG. 12 corresponds to the plan view of FIG. 11. The electrode pattern of the patch electrode 120 of the intelligent reflecting surface 10C is the same as the electrode pattern shown in FIG. 4A.

In a plan view, the intelligent reflecting surface 10C includes a first region 101 where the patch electrode 120 and the counter electrode 130C overlap each other, and a second region 102 where the patch electrode 120 and the counter electrode 130C do not overlap each other.

In the first region 101, the counter electrode 130C includes a plurality of second opening portions 131C having a second opening area (see FIG. 12). The planar shape of each of the plurality of second opening portions 131C is polygonal. However, the sizes of the plurality of second opening portions 131C are not the same. That is, the second opening area of the plurality of second opening portions 131C increases from the inside to the outside in the first region 101. In addition, the second opening area of the second opening portion 131C located furthest inside the first region 101 is the same as the first opening area of the first opening portion 121. However, in order to improve the brightness in the vicinity of the center in the first region 101, it is preferable that the second opening area of the second opening portion 131 located furthest inside the first region 101 is larger than the first opening area of the first opening portion 121.

In addition, in the present modification, the electrode pattern of the counter electrode 130C in the first region 101 is shown to completely overlap the electrode pattern of the patch electrode 120 in the first region 101. However, a configuration in which the electrode pattern of the counter electrode 130C in the first region 101 overlaps the electrode pattern of the patch electrode 120 in the first region 101 with a slight offset is also possible.

As described above, in the first region 101 (the reflecting antenna cell 100) of the intelligent reflecting surface 10C, the opening area of the plurality of second opening portions 131C increases from the inside to the outside of the first region 101. In a transparent intelligent reflecting surface, the shape of the first region 101 is easily visible at the boundary between the first region 101 in which the patch electrode 120 is provided, and the second region 102 in which the patch electrode 120 is not provided. Therefore, by gradually changing the brightness of the light transmitted through the first region 101, that is, by gradually increasing the brightness of the light transmitted from the inside to the outside of the first region 101, the difference in transparency at the boundary between the first region 101 and the second region 102 can be made less noticeable. Further, the first opening portion 121 of the first region 101 and the third opening portion 132 of the second region 102 are the same in shape and size. Therefore, since the brightness of light transmitted through the first region 101 is approximately the same as the brightness of light transmitted through the second region 102, the in-plane variation in transparency in the intelligent reflecting surface 10B can be reduced. Further, in the inside of the first region 101 of the intelligent reflecting surface 10C, the area of the region where the patch electrode 120 and the counter electrode 130 overlap each other can be increased. As a result, the increase in reflection loss of the intelligent reflecting surface 10C can be suppressed.

### Modification 4

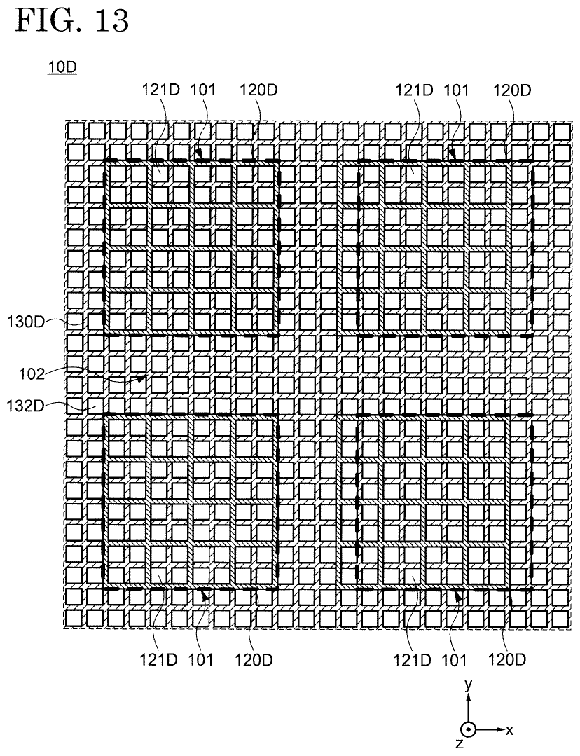

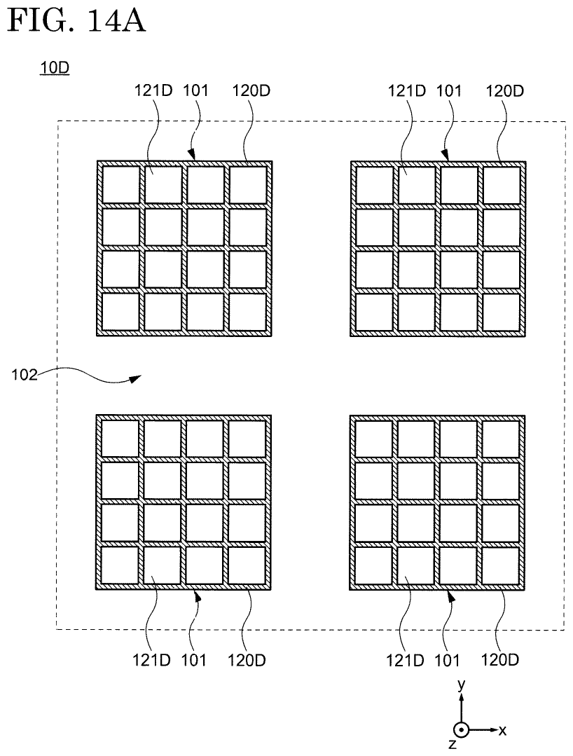

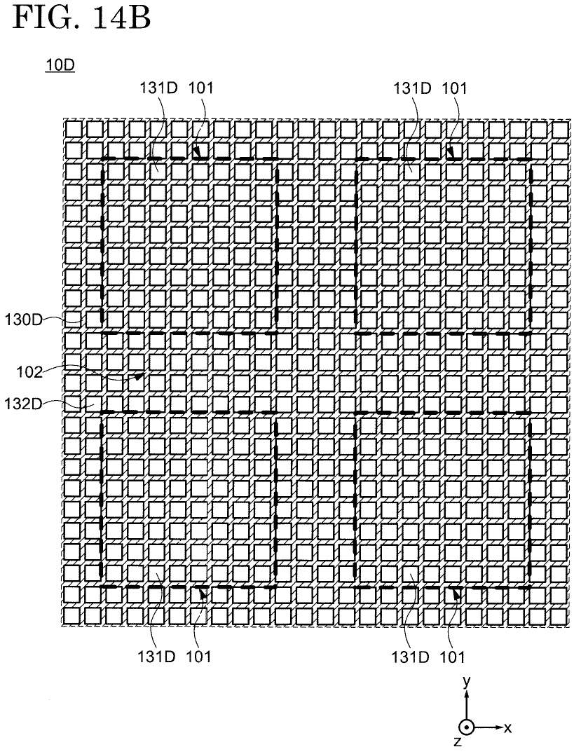

An intelligent reflecting surface 10D, which is the fourth modification of the intelligent reflecting surface 10, is described with reference to FIGS. 13 to 14B. In addition, hereinafter, when the intelligent reflecting surface 10D includes the same components as the intelligent reflecting surface 10, the description of those components may be omitted.

FIG. 13 is a schematic plan view showing configurations of a patch electrode 120D and a counter electrode 130D of the intelligent reflecting surface 10D according to an embodiment of the present invention. FIG. 14 is a plan view corresponding to the region A in FIG. 1. Further, FIG. 14A is a schematic plan view showing an electrode pattern of the patch electrode 120D of the intelligent reflecting surface 10D according to an embodiment of the present invention, and FIG. 14B is a schematic plan view showing an electrode pattern of the counter electrode 130D of the intelligent reflecting surface 10D according to an embodiment of the present invention. The plan views of FIGS. 14A and 14B correspond to the plan view of FIG. 13.

In a plan view, the intelligent reflecting surface 10D includes a first region 101 where the patch electrode 120D and the counter electrode 130D overlap each other, and a second region 102 where the patch electrode 120D and the counter electrode 130D do not overlap each other.

In the first region 101, the patch electrode 120A includes a plurality of first opening portions 121D having a first opening area (see FIG. 14A). Further, in the first region 101, the counter electrode 130D includes a plurality of second opening portions 131D having a second opening area (see FIG. 14B). Although the planar shape of each of the first opening portions 121D and the second opening portions 131D is rectangular, the cross-sectional shape is not limited thereto. The second opening area is smaller than the first opening area. Further, the first opening portions 121D and the second opening portions 131D overlap each other. Specifically, one of the plurality of first opening portions 121D overlaps four of the plurality of second opening portions 131D.

In the second region 102, the counter electrode 130D includes a plurality of third opening portions 132D having a third opening area (see FIG. 14B). Although the planar shape of the third opening portion 132D is rectangular, the cross-sectional shape is not limited thereto. The third opening area is the same as the second opening area. Therefore, the third opening portion 132D has the same configuration as the second opening portion 131D. In other words, the counter electrode 130D has a plurality of second opening portions 131D having a second opening area in each of the first region 101 and the second region 102.

The intelligent reflecting surface 10D has a configuration in which, in the first region 101 of the intelligent reflecting surface 10, the size of the first opening area of the first opening portion 121 provided in the patch electrode 120 and the size of the second opening area of the second opening portion 131 provided in the counter electrode 130 are inverse. Even in the first region 101 of the intelligent reflecting surface 10D, the first opening area of the first opening portion 121D is large, so it is difficult for light to be blocked by the patch electrode 120D.

As described above, in the first region 101 (the reflecting antenna cell 100) of the intelligent reflecting surface 10D, the first opening area of the first opening portion 121D provided in the patch electrode 120D is larger than the second opening area of the second opening portion 131D provided in the counter electrode 130D. Therefore, since light shielding by the patch electrode is reduced, the amount of light transmitted through the first region 101 increases. As a result, the transparency of the first region 101 is improved. Further, the second opening portion 131D in the first region 101 and the third opening portion 132D in the second region 102 are the same in shape and size. Therefore, since the brightness of the light transmitted through the first region 101 is approximately the same as the brightness of the light transmitted through the second region 102, the in-plane variation in transparency in the intelligent reflecting surface 10D can be reduced.

### Modification 5

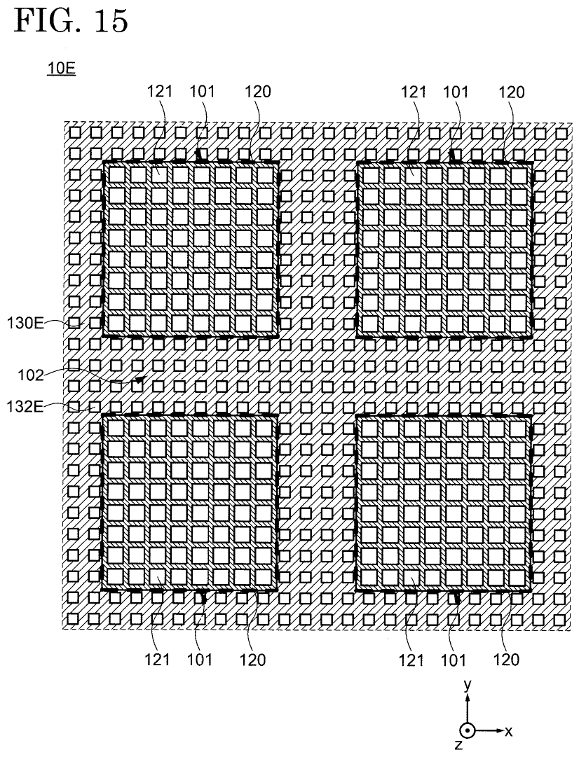

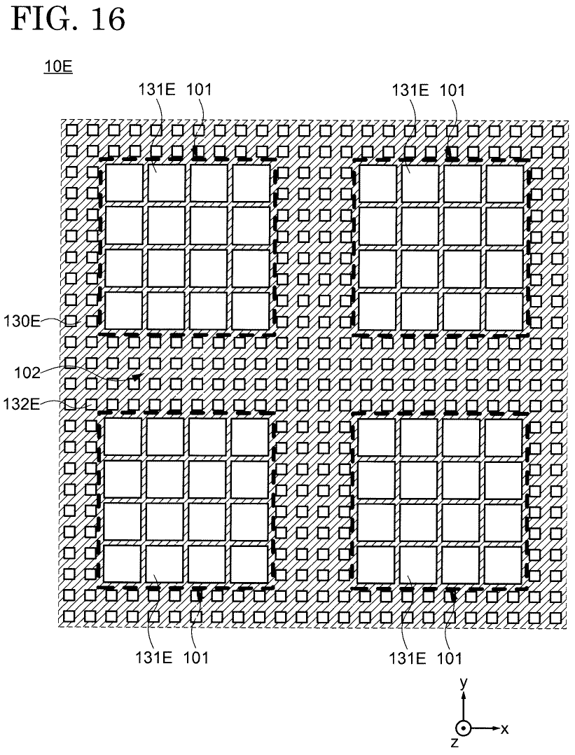

An intelligent reflecting surface 10E, which is the fifth modification of the intelligent reflecting surface 10, is described with reference to FIGS. 15 and 16. In addition, hereinafter, when the intelligent reflecting surface 10E includes the same components as the intelligent reflecting surface 10, the description of those components may be omitted.

FIG. 15 is a schematic plan view showing configurations of the patch electrode 120 and a counter electrode 130E of the intelligent reflecting surface 10E according to an embodiment of the present invention. FIG. 15 is a plan view corresponding to the region A in FIG. 1. FIG. 16 is a schematic plan view showing an electrode pattern of the counter electrode 130E of the intelligent reflecting surface 10E according to an embodiment of the present invention. The plan view of FIG. 16 corresponds to the plan view of FIG. 15. The electrode pattern of the patch electrode 120 of the intelligent reflecting surface 10E is the same as the electrode pattern shown in FIG. 4A.

In a plan view, the intelligent reflecting surface 10E includes a first region 101 where the patch electrode 120 and the counter electrode 130E overlap each other, and a second region 102 where the patch electrode 120 and the counter electrode 130E do not overlap each other.

In the first region 101, the counter electrode 130E includes a plurality of second opening portions 131E having a second opening area (see FIG. 16). The planar shape of the second opening portion 131E is rectangular. The second opening area is larger than the first opening area. Further, the first opening portion 121 and the second opening portion 131E overlap each other. Specifically, one of the plurality of second opening portions 131E overlaps four of the plurality of first opening portions 121.

In the second region 102, the counter electrode 130E includes a plurality of third opening portions 132E having a third opening area (see FIG. 16). The planar shape of the third opening portion 132E is rectangular. The third opening area is smaller than the first opening area. Only the counter electrode 130E is provided in the second region 102. On the other hand, the patch electrode 120 and the counter electrode 130E are provided in the first region 101. Therefore, light incident on the intelligent reflecting surface 10E is more easily blocked in the first region 101 than in the second region 102. Thus, in the second region 102 of the intelligent reflecting surface 10E, the opening area of the third opening portions 132 is reduced, and the brightness of the light transmitted through the second region 102 is adjusted to match the brightness of the light transmitted through the first region 101. As a result, since the difference between the transparency of the first region 101 and the transparency of the second region 102 becomes smaller, the in-plane variation in transparency of the intelligent reflecting surface 10E can be reduced.

As described above, in the first region 101 (the reflecting antenna cell 100) of the intelligent reflecting surface 10E, the second opening area of the second opening portion 131E provided in the counter electrode 130E is larger than the first opening area of the first opening portion 121 provided in the patch electrode 120. Therefore, since light shielding by the counter electrode 130E is reduced, the amount of light transmitted through the first region 101 increases. As a result, the transparency of the first region 101 is improved. Further, the third opening area of the third opening portion 132E provided in the counter electrode 130E in the second region 102 is smaller than the opening area of the first opening portion 121 provided in the patch electrode 120 in the first region 101. Therefore, although light shielding is more likely in the second region 102 than in the first region 101, the brightness of the light transmitted through the second region 102 can be adjusted. Therefore, since the brightness of the light transmitted through the first region 101 can be adjusted to be approximately the same as the brightness of the light transmitted through the second region 102, the in-plane variation in transparency in the intelligent reflecting surface 10E can be reduced.

Embodiments and modifications of the present invention can be combined as appropriate as long as they do not contradict each other. Based on each embodiment, any addition, deletion or design change of configuration components, or any addition, omission or change of conditions of the process, made by a person skilled in the art as appropriate, is also included in the scope of the invention, as long as it has the gist of the invention.

It is understood that other advantageous effects different from the advantageous effects resulting from the mode of each embodiment disclosed above, but which are obvious from the description of the present specification or which can be easily foreseen by a person skilled in the art, are naturally brought about by the present invention.

What is claimed is:

1. An intelligent reflecting surface, comprising:
a patch electrode over a first substrate;
a counter electrode over a second substrate different from the first substrate;
a liquid crystal layer between the patch electrode and the counter electrode; and
in a plan view, a first region in which the counter electrode overlaps the patch electrode and a second region in which the counter electrode does not overlap the patch electrode,
wherein in the first region, the patch electrode comprises a plurality of first opening portions having a first opening area, and the counter electrode comprises a plurality of second opening portions having a second opening area,
wherein in the second region, the counter electrode comprises a plurality of third opening portions having a third opening area,
wherein the plurality of second opening portions overlaps the plurality of first opening portions, and
wherein the second opening area is larger than the first opening area.

2. The intelligent reflecting surface according to claim 1, wherein the third opening area is equal to the first opening area.

3. The intelligent reflecting surface according to claim 1, wherein the third opening area is smaller than the first opening area.

4. The intelligent reflecting surface according to claim 1, wherein an aperture ratio of the counter electrode in the second region is smaller than an aperture ratio of the counter electrode in the first region.

5. The intelligent reflecting surface according to claim 1, wherein one of the plurality of second opening portions overlaps two to four of the plurality of first opening portions.

6. The intelligent reflecting surface according to claim 1, wherein the plurality of second opening portions has the second area that increases from an inside to an outside of the first region.

7. The intelligent reflecting surface according to claim 1, wherein each of the plurality of first opening portions, the plurality of second opening portions, and the plurality of third opening portions has a rectangular planar shape.

8. The intelligent reflecting surface according to claim 1, wherein each of the plurality of first opening portions, the plurality of second opening portions, and the plurality of third opening portions has a circular planar shape.

9. The intelligent reflecting surface according to claim 1, further comprising a switching element over the first substrate,
wherein the patch electrode is electrically connected to the switching element.

10. An intelligent reflecting surface, comprising:
a patch electrode over a first substrate;
a counter electrode over a second substrate different from the first substrate;
a liquid crystal layer between the patch electrode and the counter electrode; and
in a plan view, a first region in which the counter electrode overlaps the patch electrode and a second region in which the counter electrode does not overlap the patch electrode,
wherein in the first region, the patch electrode comprises a plurality of first opening portions having a first opening area, and the counter electrode comprises a plurality of second opening portions having a second opening area,
wherein in the second region, the counter electrode comprises a plurality of third opening portions having a third opening area,
wherein the plurality of second opening portions overlaps the plurality of first opening portions, and
wherein the second opening area is smaller than the first opening area.

11. The intelligent reflecting surface according to claim 10, wherein the third opening area is equal to the first opening area.

12. The intelligent reflecting surface according to claim 10, wherein the third opening area is smaller than the first opening area.

13. The intelligent reflecting surface according to claim 10, wherein an aperture ratio of the counter electrode in the second region is smaller than an aperture ratio of the counter electrode in the first region.

14. The intelligent reflecting surface according to claim 10, wherein one of the plurality of first opening portions overlaps two to four of the plurality of second opening portions.

15. The intelligent reflecting surface according to claim 10, wherein the plurality of first opening portions has the first area that increases from an inside to an outside of the first region.

16. The intelligent reflecting surface according to claim 10, wherein each of the plurality of first opening portions, the plurality of second opening portions, and the plurality of third opening portions has a rectangular planar shape.

17. The intelligent reflecting surface according to claim 10, wherein each of the plurality of first opening portions, the plurality of second opening portions, and the plurality of third opening portions has a circular planar shape.

18. The intelligent reflecting surface according to claim 10, further comprising a switching element over the first substrate,
wherein the patch electrode is electrically connected to the switching element.
